(19) United States
(12) Patent Application Publication
(10) Pub. No.: US 2013/0321904 A1
(43) Pub. Date: Dec. 5, 2013

(54) Solar Control Window Glass

(71) Applicant: Darryl J. Costin, Westlake, NY (US)

(72) Inventor: Darryl J. Costin, Westlake, NY (US)

(21) Appl. No.: 13/896,401

(22) Filed: May 17, 2013

Related U.S. Application Data
(60) Provisional application No. 61/648,164, filed on May 17, 2012.

(51) Int. Cl. G02B 5/20; G06F 17/50

(52) U.S. Cl. CPC G02B 5/208; G06F 17/5009
USPC 359/350; 703/6

(57) ABSTRACT

Glass formulations and methods of setting the characteristics and formulations are described. The method includes determining climate characteristics of an area in which the glasses to be used, using the climate characteristics to determine heating and cooling costs for the geographical area, using the heating costs as part of a model to select an optimum glass assembly comprising a dual pane glass assembly, using an optimization model by providing higher weighting on low emissivity in a northern climates, and high or waiting of solar control in a more southern climate.

This application claims priority from provisional application No. 61/648,164, filed May 17, 2012, the entire contents of which are herewith incorporated by reference.

### BACKGROUND

One powerful means to reduce energy costs and CO₂ emissions is to use solar control glasses for houses and buildings. Greater use of solar control glass in homes and buildings could likely save over a hundred million tons of CO₂ emissions annually. Conversely, homes and buildings that do not have the optimum energy efficient glass are a major source of unnecessary CO₂ emissions and fossil fuel. Of course, the energy savings from greater use of such solar control glasses would be significant on a global basis and dramatically reduce total energy requirements.

The glass industry introduced low emissivity (low E) glass to the marketplace over fifteen years ago and such glass has gained market share to a majority position over the years. The low E glass keeps the heat inside the building or house by reflecting the long wavelength radiation back into the house. Hence, low E glass reduces heating bills.

Two means to achieve low emissivity glass are to physically vapor deposit (PVD) or chemically vapor deposit (CVD) doped oxide coatings on the base glass. Such coatings can be layers of indium doped tin oxide. Such products are often much more expensive than the base glass. Some companies have used the PVD technology to improve the solar optical properties of the coating by the addition of extra layers of metal/doped metal oxide.

There are actually two means to reduce the solar transmission of glass. The first method is to use solar absorbing glasses that reduce the direct solar transmission. The limitation in using traditional solar absorbing glasses in reducing solar transmission is that reducing the solar transmission is usually associated with a corresponding reduction in visible light transmission. The visible light transmission for automotive windshields is 70%; whereas, the visible light transmission of glass behind the passenger for SUVs and Vans can be as low as 25%. The visible light transmission can be 40-70% for buildings and 80-90% for homes. A second method is to deposit physical vapor deposited or chemical vapor deposited coating stacks on the glass that allow the transmission of visible light but reflects the solar radiation.

The authors believe that for the majority of climates in the world and certainly for southern regions, air conditioning or cooling costs dominate the energy cost equation. For these areas, what is needed is solar control glasses that do not let the heat inside the building in the first place. The selection of the optimum glass to reduce total energy costs would be dependent upon the specific geographical area and the relationship between the heating and cooling costs in that area.

Further, the use of solar control glasses for automotive windshields and glass in the sides and rear of the car would reduce air conditioning loads and improve passenger comfort. Yet there has been little progress in the last twenty years in the glass industry to develop optimum solar control glasses for the residential, commercial and automotive marketplaces.

The current level of technology to achieve maximum solar control in glass for buildings is to use (PVD) coatings that allow visible light to enter the building but repels solar heat. Such coatings can be made from layers of doped oxides and metal, for example, indium tin oxide and silver. Such PVD coatings are typically deposited on clear or tinted glass that offer very little absorption. These solar control products rely specifically upon the ability of the PVD coating to reflect the solar radiation while allowing the visible light to enter. Once the optimum PVD coating is deposited on the glass, current commercial practice suggests that nothing more can be done to reduce solar transmission.

### SUMMARY

Current commercial practice suggests that nothing more can be done to reduce solar transmission once an optimum PVD coating has been deposited on the glass. The inventor disagrees as per the invention disclosed below.

### DESCRIPTION OF THE EMBODIMENTS

The inventor has invented a novel window product for homes and buildings that achieves low direct solar transmission at reduced cost.

The inventor believes that a problem with the current level of technology is that the difference between the theoretical best performing glasses and those that are commercially available is quite significant. For example, the lowest solar transmission for windshield glass with a 70% visible transmission is estimated to be less than 15% on a theoretical basis. Yet the solar transmission for the best commercial windshield glass is greater than 40% at 4 mm thickness. Significant differences between the theoretical best solar transmission for residential, glass behind the “B” pillar for autos and trucks and the best commercial glass products reveal the same opportunity to markedly improve new solar control glass.

Windows are typically composed of two panes of glass with a spacing in between for insulation. Table 1 illustrates the visible transmission and solar transmission for a window consisting of two panes of 4 mm clear glass. The visible and solar transmission of the window is simply the product of the individual visible or solar transmission of the individual panes. So, for example, the visible transmission of 81% for the window in Table 1 is obtained by multiplying the visible transmission of 90% for the inner pane times the visible transmission of 90% for the outer pane. The same holds for the computation of the solar transmission of the window.

TABLE 1

| | Inner Pane | Outer Pane | Window |
|---|---|---|---|
| Visible Transmission % | 90 | 90 | 81 |
| Solar Transmission % | 83 | 83 | 69 |

The majority of windows now consist of the outer pane of clear glass and an inner pane of clear glass with a low E type coating. The visible and solar transmission for a number of commercial low E products configured like this are shown in Table 2.

TABLE 2

| | | | Visible | Solar |
|---|---|---|---|---|
| | | Thickness | Transmission | Transmission |
| Low E Product | Manufacturer | (mm) | (%) | (%) |
| LowE-272 | Cardinal | 3.9 | 71 | 37 |
| LowE-270 | Cardinal | 3.9 | 69 | 33 |
| LowE-366 | Cardinal | 3.9 | 64 | 24 |
| Sungate 400 | PPG | 3 | 78 | 57 |
| Sungate 600 | PPG | 3 | 72 | 54 |
| Sungate 70XL | PPG | 3 | 64 | 25 |
| Energy Adv | Pilkington | 4 | 71 | 57 |

In each case shown in Table 2, clear glass is required for both panes because of the high visible transmission of clear glass and since the low E coating reduces the visible transmission of the window. Cardinal's ultra performance product LowE-366 consists of three layers of silver in between metal oxide layers and is thus very expensive to manufacture. However the product delivers extraordinary low solar transmission of 24% with a corresponding visible transmission of 64% for 3.9 mm glass.

One of the author's inventions is to replace this window with a glass that has a visible transmission of 81% and a solar transmission of 49% for the inner and outer pane of glass. For such a window configured with two panes of such glass, the visible and solar transmission is computed in Table 3.

TABLE 3

| | Inner Pane | Outer Pane | Window |
|---|---|---|---|
| Visible Transmission % | 81 | 81 | 65 |
| Solar Transmission % | 49 | 49 | 24 |

Now let's compare the visible and solar transmission of this invention with the very best Low E product that the leading manufacturer has to offer as shown in Table 4.

TABLE 4

| | Visible | Solar |
|---|---|---|
| Product | Transmission (%) | Transmission (%) |
| LowE-366 | 64 | 24 |
| New Invention | 65 | 24 |

Note that this is surprisingly equal to or slightly superior in solar-optical properties, but is realized by using two panes of the same inventive glass which is an embodiment of this invention. Furthermore, and of major importance, the manufacturing cost for the product of this invention would be a fraction of the cost of a triple silver layered physical vapor deposited product such as LowE-366. Even further, the typical handling issues associated with soft coating such as this are totally avoided.

The one apparent advantage of the LowE-366 product is the low emissivity which is not achieved by the glass of this disclosed embodiment. The low emissivity glass keeps the heat inside the building or house by reflecting the long wavelength radiation back into the house. Hence, low E glass reduces heating bills. However, the author believes that for the majority of climates in the world and certainly for southern regions, air conditioning or cooling costs dominate the energy cost equation. For these areas, what is needed is solar control glasses that do not let the heat inside the building in the first place. Low E glass would seem to be a significant disadvantage in these cases because it keeps the heat inside the house.

Another embodiment of this invention is to utilize glass that has different characteristics for outside and inside, but neither of which is PVD or CVD deposited. In one embodiment, one absorbing glass is used with the properties of 81% visible transmission and 49% solar transmission as the outer pane and clear glass with a 90% visible transmission and 83% solar transmission as the inner pane. The visible and solar transmission for this window configuration is shown in Table 5.

TABLE 5

| | Inner Pane | Outer Pane | Window |
|---|---|---|---|
| Visible Transmission % | 81 | 90 | 73 |
| Solar Transmission % | 49 | 83 | 41 |

Comparing this product to two Low E products with high visible transmission reveals the extraordinary properties of the inventive glass as shown in Table 6. Again the glasses of this invention are much less expensive than the physical vapor deposited Low E glass because they require no coating.

TABLE 6

| | Visible | Solar |
|---|---|---|
| Product | Transmission (%) | Transmission (%) |
| Sungate 600 | 72 | 54 |
| Energy Adv | 71 | 57 |
| This embodiment | 73 | 41 |

Yet another embodiment is to configure window glass with both panes of glass with visible transmissions greater than 75% and solar transmissions less than 50%.

Another embodiment is to configure window glass with one inner pane of glass with visible transmission greater than 60% and solar transmission less 40% with than one clear pane of glass.

If the low emissivity is a requirement for extremely cold climates, than another embodiment is to configure a window with an inner pane of typical low E glass with an outer pane with visible transmission greater than 80% and solar transmission less than 50%.

By coupling a variety of absorbing glasses as the outer pane with low E glasses as the inner pane, a whole family of products optimally configured can be assembled with varying visible and solar characteristics that may be most suitable in particular climates across the world, which represents yet another embodiment of this invention. This optimum configuration will change depending on the specific geographical location where the glass is used and the relative heating and cooling costs in that area. So yet another embodiment is to identify the heating and cooling costs for a specific geographical area, and then couple the energy cost equations with the solar and emissivity properties of the glass so as to select the optimum glass for specific areas using an optimization model. For example, although both solar control and low emissivity would be needed for the optimum glass in the far northern climates, low emissivity would have a higher weighting in the optimization model. Conversely, in the southern climates, solar control would have the highest weighting in the optimization equation. And in extreme heat, the optimum glass product could be one that maximizes the solar reflectively, minimizes the solar transmission and does not even have a low emissivity coating.

Another embodiment of this invention is to apply the low E coatings on absorbing (non clear) glass that have visible transmissions less than 85% with solar transmissions less than 65%.

Glasses used in homes and buildings often consist of insulated glazing with two panes of glass with a spacing between the panes. These units use the thermal and acoustic insulating properties of a gas or vacuum or simply air contained in the space formed by the unit. So another embodiment is to use some or all of the methods disclosed in this application and embodiments above to develop the optimum insulated glass products to minimize energy costs. In this case, the specific glass and presence or absence of coatings on the individual glass panes could be properly modeled as a total unit for optimum performance. The solar reflectance, solar transmission, emissivity and absorption could be quite different for the outer glass pane than that for the inner glass pane, which is a characteristic of this embodiment.

The modeling carried out herein can be done on any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of setting characteristics for glass, comprising:
determining climate characteristics of a geographical area in which the glass is to be used;
using said climate characteristics to determine heating and cooling costs for the geographical area;
using said heating costs as part of a model to select an optimum glass assembly comprising a dual pane glass assembly, using an optimization model by providing higher weighting on low emissivity in a northern climates, and higher weighting of solar control in a more southern climate.

2. The method as in claim 1, wherein in the southern climate, a glass is used that does not have a low E coating.

3. The method as in claim 1, wherein said optimum glass assembly comprises a first item of glass which is absorbing, and a second item of glass which is PVD or CVD coated.

4. The method as in claim 3, wherein said absorbing glass is used as an outer pane and a low E glass is used as an inner pane.

5. The method as in claim 4, wherein said outer pane has a visible transmission less than 85% and a solar transmission less than 65%.

6. The method as in claim 4, wherein said outer pane has at least 80% visible transmission and less than 50% solar transmission.

7. A glass window having first and second panes of glass, the first pane being an absorbing pane intended to face an outside, and the second pane facing an indoors and being low E glass with a PVD or CVD coating, where an outer pane has at least 80% visible transmission and less than 50% transmission.

8. The window as in claim 7, wherein said first pane and said second pane have the same visible transmission and solar transmission characteristics.

9. The window as in claim 8, where both said first pane and said second pane have different visible transmission and solar transmission characteristics.

10. A glass window having first and second panes of glass, the first pane being an outer pane intended to face the outside, and the second pane facing an indoors, where the outer pane has at least 60% visible transmission and less than 40% solar transmission, and neither the inner pane or the outer pane is PVD or CVD coated.

11. A glass window having first and second panes of glass, the first pane being an outer pane intended to face the outside, and the second pane facing an indoors, where the outer pane has at least 75% visible transmission and less than 50% solar transmission, and neither the inner pane or the outer pane is PVD or CVD coated.

12. A glass window having first and second panes of glass, the first pane being an outer pane intended to face the outside, and the second pane facing an indoors, where the outer pane has at least 80% visible transmission and less than 50% solar transmission, and neither the inner pane or the outer pane is PVD or CVD coated.

13. The window as in claim 10, wherein said first pane and said second pane have the same visible transmission and solar transmission characteristics.

14. The window as in claim 10, where both said first pane and said second pane have different visible transmission and solar transmission characteristics.
